(19) United States
(12) Patent Application Publication
(10) Pub. No.: US 2010/0250582 A1
(43) Pub. Date: Sep. 30, 2010

(54) SYSTEMS, METHODS, AND SOFTWARE FOR SEARCHING AND RETRIEVING FACT-CENTRIC DOCUMENTS

(75) Inventor: Steven Anderson, St. Paul, MN (US)

Correspondence Address: Thomson Reuters c/o Intellectual Property Dept.;Attn: Michelle Chang, 3 Times Square, New York, NY, 10036, US

(73) Assignee: Thomson Reuters Global Resources, Baar (CH)

(21) Appl. No.: 12/565,614

(22) Filed: Sep. 23, 2009

Related U.S. Application Data
(60) Provisional application No. 61/192,931, filed on Sep. 23, 2008.

(51) Int. Cl. G06F 17/30

(52) U.S. Cl. 707/769; 707/E17.014

(57) ABSTRACT

One exemplary system receives a user query containing at least one fact and normalizes that query into a query footprint. Within the information-retrieval system, each document has a pre-computed document footprint. The document footprint can take into account the facts and/or anchor terms and their relationships to other facts, anchor terms and/or general terms within the document. The query footprint relates to each document footprint and any document footprint that is within a similarity threshold is selected. Finally, a signal associated with the documents associated with the selected document footprints is transmitted to the user.

### CROSS-REFERENCE TO RELATED APPLICATION

This application claims priority to U.S. provisional application 61/192,931 filed on Sep. 23, 2008. The provisional application is incorporated herein by reference.

### COPYRIGHT NOTICE AND PERMISSION

A portion of this patent document contains material subject to copyright protection. The copyright owner has no objection to the facsimile reproduction by anyone of the patent document or the patent disclosure, as it appears in the Patent and Trademark Office patent files or records, but otherwise reserves all copyrights whatsoever. The following notice applies to this document: Copyright© 2009, Thomson Reuters.

### FIELD OF THE INVENTION

Various embodiments of the present invention concern information-retrieval systems, such as those that provide documents that contain at least one fact or factual description.

### BACKGROUND OF THE INVENTION

The United States legal system is based on precedent and requires that attorneys look to decisions in past cases to argue the outcome of their current matter. The more a case is “similar” to their current matter, the more authority the past decision have be given by the court. Moreover, the need for similar cases exists throughout all stages of litigation. The similarity of a case is determined by three factors, namely:

1. applicable law (same statute, legal theory, jurisdiction, etc. . . . );

2. procedural status (same type of motion/rule being used); and

3. facts (same/similar situational factors).

Of the three elements listed above, lawyers often focus on the facts of their case before considering the law and procedure for very practical reasons. Specifically, lawyers are often familiar with “the law” in their particular areas of practice and are generally familiar with the nuances involved. The same is true for procedural considerations. A relatively small sub-set of procedural rules is commonly used throughout litigation (specifically, 80% of all motions filed are motions to dismiss or suppress evidence, e.g., summary judgment motions and motions in limine, etc.). But while the same set of familiar laws and rules may be applied by a lawyer in subsequent matters, the facts change from case to case. More importantly, characterizing the facts is usually more critical to success than legal analysis alone because cases are never factually identical.

Even where several factual similarities align with a previously decided case, a client in any given matter may not be best served by focusing on similarities. In those situations, lawyers are trained to look for small, but legally significant factual 1 distinctions to create their analysis and argument. This reality substantially impacts how lawyers think about legal research generally. While much of their research in statutes, codes and rules requires that they find the exact set of “laws” that control the situation, they know that the interpretation of those laws is found in multiple court rulings that need to be analyzed, distinguished, reconciled and ultimately summarized in the documents they file with the court.

Lawyers not only try to find cases factually similar to their current case, they also try to find those factually similar cases that have been decided by appellate courts. An appellate opinion, drafted by a judge, is characteristic of legal memoranda with at least one added element—a ruling. The facts contained in the opinion support the ruling while all others are omitted. Thus, these opinions of judges help focus lawyers on the types of facts that are most important in applying the law at issue. The text of these opinions combined with headnotes produces a corpus of data within the appellate decisions uniquely suited for high-level queries combing simple legal and factual search terms.

Although the classic research scenario defined above is an effective way to conduct appellate case law research, it is a much less effective technique for finding new trial court materials as part of the litigator initiative for three reasons. First, appellate cases seldom contain the degree of factual detail available in trial court materials, thus eliminating opportunity to find factual nuances in the original search. Second, although linking and KeyCite® features can direct a user to trial court materials associated with an appellate case that is retrieved in the case law query, integration features do not direct the user to trial court materials that are not associated with the cases retrieved. The volume of trial court materials available far exceeds appellate cases within a short period of time and many are not be part of an appellate case history. Finally, and most important, lawyers searching for appellate cases may not review trial court materials, e.g. available on Westlaw (Jacie, add trademark). This may be due to a lack of time, a budget constraint imposed by the client, or other reason.

Accordingly, the present inventors have recognized a need for improvement of information-retrieval systems for fact-centric documents and potentially other document retrieval systems.

### SUMMARY OF THE INVENTION

To address this and/or other needs, the present inventors devised, among other things, systems, methods, and software that facilitate the retrieval of highly material fact-centric documents in response to queries for fact patterns. One exemplary system receives a user query containing at least one fact and normalizes that query into a query footprint. Within the information-retrieval system, each document has a pre-computed document footprint. The document footprint takes into account the facts and/or anchor terms and their relationships to other facts, anchor terms and/or general terms within the document. The query footprint relates to each document footprint and any document footprint that is within a similarity threshold is selected. Finally, a signal associated with the documents associated with the selected document footprints is transmitted to the user.

### BRIEF DESCRIPTION OF DRAWINGS

FIG. 1 is a diagram of an exemplary information-retrieval system 100 corresponding to one or more embodiments of the invention;

FIG. 2 is a flowchart corresponding to one or more exemplary methods of operating system and one or more embodiments of the invention;

FIG. 2a is a flowchart corresponding to one or more exemplary methods of operating system and one or more embodiment of the invention;

FIGS. 3a-d are exemplary interfaces corresponding to one or more embodiments of the invention; and

FIGS. 4a-d are exemplary interfaces corresponding to one or more embodiments of the invention.

### DETAILED DESCRIPTION OF EXEMPLARY EMBODIMENTS

This description, which references and incorporates the above-identified Figures, describes one or more specific embodiments of an invention. These embodiments, offered not to limit but only to exemplify and teach the invention, are shown and described in sufficient detail to enable those skilled in the art to implement or practice the invention. Thus, where appropriate to avoid obscuring the invention, the description may omit certain information known to those of skill in the art.

Additionally, this document incorporates by reference U.S. Pat. No. 7,065,514 which was filed on Nov. 5, 2001 and issued on Jun. 20, 2006; U.S. Pat. No. 7,567,961 which was filed on Mar. 24, 2006 and issued on Jul. 28, 2009. One or more embodiments of the present application may be combined or otherwise augmented by teachings in the referenced applications to yield other embodiments.

A fact or factual description refers to those portions of documents where the author of the document (e.g., lawyer, judge, party, witness, expert, analyst etc.) is describing the events, conditions, people, time and science surrounding the matter, or any portion of the matter, including but not limited to information about the parties involved, the circumstances surrounding the events, description of any damages to property or person, location, time and date of the event, expert analysis or testimony, other testimony, documents at issue (e.g., contracts) or exhibits used to explain the event and surrounding circumstances. Those skilled in the art will appreciated that although the exemplary embodiments of the present invention are explained in the context of litigation, the present invention may be utilized in any industry, product, or service wherein facts need to be searched, compared, and/or analyzed.

### Exemplary Information-Retrieval System

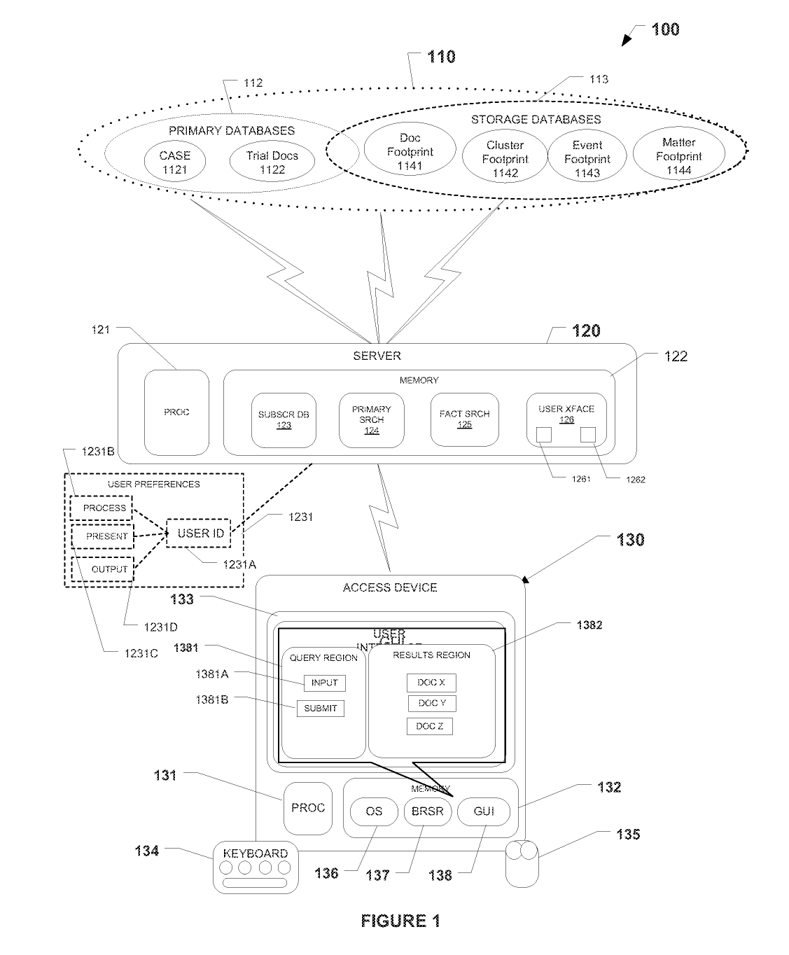

FIG. 1 shows an exemplary online information-retrieval system 100, which may be adapted to incorporate the capabilities, functions, methods, interfaces, and so forth described above. System 100 includes one or more databases 110, one or more servers 120, and one or more access devices 130.

Databases 110 include a set of primary databases 112 and a set of storage databases 113. Primary databases 112, in the exemplary embodiment, include a caselaw database 1121 and a trial documents database 1122, which respectively include judicial opinions and trial court documents. Trial court documents include but are not limited to pleadings, motions, interrogatories, jury instructions, jury verdicts, orders from trial courts, expert profiles, or exhibits. In other embodiments, the primary database additionally includes financial data, such as public stock market data, and news data. Storage databases 113, in the exemplary embodiment, include a document footprint database 1141, a cluster footprint database 1142, event footprint database 1143, and matter footprint database 1144. Other embodiments may include non-legal databases that may include, e.g., financial, scientific, health-care or other information. Still other embodiments provide public or private databases, such as those made available through INFOTRAC®

Databases 110, which take the exemplary form of one or more electronic, magnetic, or optical data-storage devices, include or are otherwise associated with respective indices (not shown). Each of the indices includes terms and phrases in association with corresponding document addresses, identifiers, and other conventional information. Databases 110 are coupled or couplable via a wireless or wireline communications network, such as a local-, wide-, private-, or virtual-private network, to server 120.

Server 120 is generally representative of one or more servers for serving data in the form of webpages or other markup language forms with associated applets, ActiveX controls, remote-invocation objects, or other related software and data structures to service clients of various “thicknesses.” More particularly, server 120 includes a processor module 121, a memory module 122, a subscriber database 123, a primary search module 124, a fact search module 125, and a user-interface module 126.

Processor module 121 includes one or more local or distributed processors, controllers, or virtual machines. In the exemplary embodiment, processor module 121 assumes any convenient or desirable form know to those skilled in the art.

Memory module 122, which takes the exemplary form of one or more electronic, magnetic, or optical data-storage devices, stores subscriber database 123, primary search module 124, fact search module 125, and user-interface module 126.

Subscriber database 123 includes subscriber-related data for controlling, administering, and managing access to databases 110 via, e.g., pay-as-you-go or subscription-based services. In the exemplary embodiment, subscriber database 123 includes one or more preference data structures, of which data structure 1231 is representative. Data structure 1231 includes a customer or user identifier portion 1231A, which is logically associated with one or more fact-research-related preferences, such as preferences 1231B, 1231C, and 1231D. Preference 1231B includes a default value governing whether factual searching functionality is enabled or disabled. Preference 1231C includes a default value governing presentation of factual search results information. Preference 1231D includes one or more default values governing other factual search related operations or parameters, such as time frames. (In the absence of a temporary user override, for example, an override during a particular query or session, the default values govern.)

Primary search module 124 includes one or more search engines and related user-interface components, for receiving and processing user queries against one or more of databases 110. In the exemplary embodiment, one or more search engines associated with search module 124 provide Boolean, tf-idf, natural-language search capabilities.

Fact search engine module 125 includes one or more search engines for receiving and converting queries into a query footprint, determining a similarity threshold between the determined facts or footprints in one or more of databases 113 and the query footprint, processing the query and its associated query footprint against one or more of databases 110, and presenting the determined facts in association with the document or one or more related documents. In some embodiments, a separate charge or additional fee is imposed for searching and/or accessing documents from the trial document database.

User-interface module 126 includes machine readable and/or executable instruction sets for wholly or partly defining web-based user interfaces, such as search interface 1261 and results interface 1262, over a wireless or wireline communications network on one or more accesses devices, such as access device 130.

Access device 130 is generally representative of one or more access devices. In the exemplary embodiment, access device 130 takes the form of a personal computer, workstation, personal digital assistant, mobile telephone, or any other device capable of providing an effective user interface with a server or database. Specifically, access device 130 includes a processor module 131 one or more processors (or processing circuits) 131, a memory 132, a display 133, a keyboard 134, and a graphical pointer or selector 135.

Processor module 131 includes one or more processors, processing circuits, or controllers. In the exemplary embodiment, processor module 131 takes any convenient or desirable form. Coupled to processor module 131 is memory 132.

Memory 132 stores code (machine-readable or executable instructions) for an operating system 136, a browser 137, and a graphical user interface (GUI) 138. In the exemplary embodiment, operating system 136 takes the form of a version of the Microsoft Windows operating system, and browser 137 takes the form of a version of Microsoft Internet Explorer. Operating system 136 and browser 137 not only receive inputs from keyboard 134 and selector 135, but also support rendering of GUI 138 on display 133. Upon rendering, GUI 138 presents data in association with one or more interactive control features (or user-interface elements). (The exemplary embodiment defines one or more portions of interface 138 using applets or other programmatic objects or structures from server 120 to implement the interfaces shown above or elsewhere in this description.)

In the exemplary embodiment, each of these control features takes the form of a hyperlink or other browser-compatible command input, and provides access to and control of query region 1381 and search-results region 1382. User selection of the control features in region 1382 results in retrieval and display of at least a portion of the corresponding document within a region of interface 138 (not shown in this figure.) Although FIG. 1 shows region 1381 and 1382 as being simultaneously displayed, some embodiments present them at separate times.

### Exemplary Information-Retrieval Method

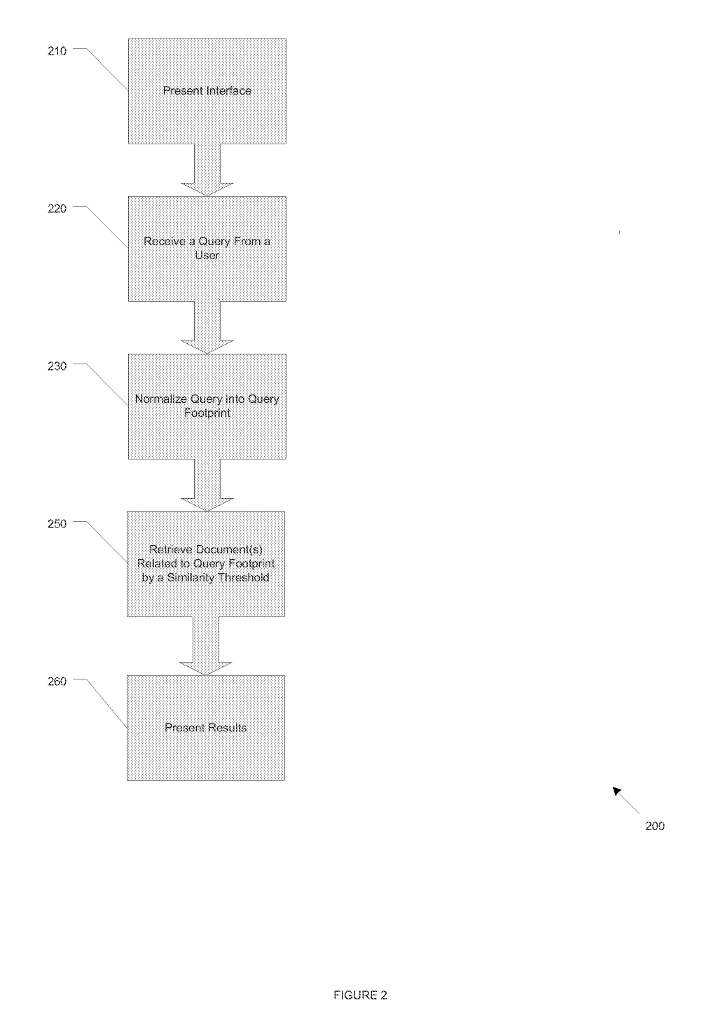

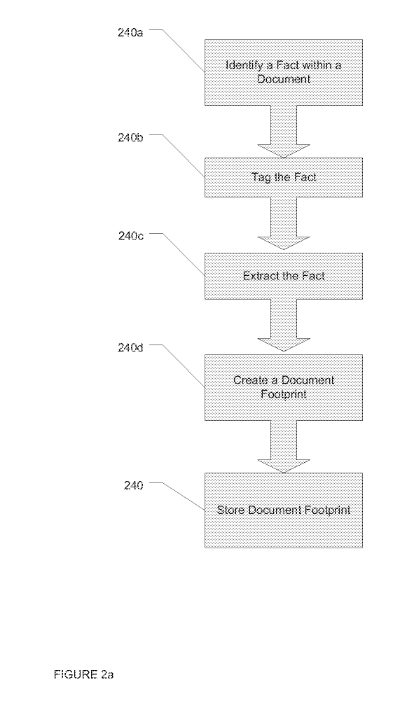

FIG. 2 shows a flow chart 200 of one or more exemplary methods of operating a system, such as system 100. Flow chart 200 includes blocks 210-250, which, like other blocks in this description, are arranged and described in a serial sequence in the exemplary embodiment. However, some embodiments execute two or more blocks in parallel using multiple processors or processor-like devices or a single processor organized as two or more virtual machines or sub processors. Some embodiments also alter the process sequence or provide different functional partitions to achieve analogous results. For example, some embodiments may alter the client-server allocation of functions, such that functions shown and described on the server side are implemented in whole or in part on the client side, and vice versa. Moreover, still other embodiments implement the blocks as two or more interconnected hardware modules with related control and data signals communicated between and through the modules. Thus, the exemplary process flow (in FIG. 2 and elsewhere in this description) applies to software, hardware, and firmware implementations.

Block 210 entails presenting a search interface to a user. In the exemplary embodiment, this entails a user directing a browser in a client access device to internet-protocol (IP) address for an online information-retrieval system, such as the Westlaw® system and then logging onto the system. Successful login results in a web-based search interface, such as interface 138 in FIG. 1 being output from server 120, stored in memory 132, and displayed by client access device 130.

Using interface 138, the user can define or submit a factual query and cause it to be output to a server, such as server 120. In other embodiments, a query may have been defined or selected by a user to automatically execute on a scheduled or event-driven basis. In these cases, the query may already reside in memory of a server for the information-retrieval system, and thus need not be communicated to the server repeatedly. Execution then advances to block 220.

Block 220 entails receipt of a user's query. In some embodiments, the query string includes a set of terms and/or connectors, and in other embodiment includes a natural-language string. In other embodiments, the query has been user-defined as a factual query. Yet other embodiments automatically recognize the query as a factual query without user definition. Also, in some embodiments, the set of target databases is defined automatically or by default based on the form of the system or search interface. In any case, execution continues at block 230.

Block 230 entails transforming the user's query into a query or factual footprint. Exemplary embodiments of the transformation process include normalizing the query and/or parsing the normalized query using methods known to those skilled in the art. In at least one embodiment, the normalized parsed query becomes the query footprint. Other embodiments may take the normalized parsed query, relate the query terms to each other, and create a query footprint from the terms and their relationships to each other. While the initial query may take on various formats, the query footprint should have a comparable format to the pre-computed document footprints (described below) so that the two types of footprints can be searched, analyzed, compared and/or retrieved.

In response to the query, block 250 entails identifying a document having a pre-computed document footprint related to the query footprint by a similarity threshold. A footprint captures the essence of the fact patterns contained therein. A footprint can be generated in one of three ways: 1) manually (written by a legally trained editor with the support of all tools and processes similar to writing headnotes), 2) electronically (machine automated read of word pairings, etc.), or 3) a combination of manual and electronic review. FIG. 2a shows an exemplary embodiment 240, the fact portions within a document and the facts within the fact portions are identified manually, electronically or a combination 240a. The facts are then tagged 240b and extracted 240c. If any relationships can be generated between the facts within the document, those relationships along with the tagged and extracted facts are utilized in creating a document footprint 240d. Another exemplary embodiment, a document footprint is created by first determining the anchor terms within the document. Then the anchor terms are utilized to determine their relationships to other anchor terms and/or general terms within the document. Another embodiment of the present invention includes using facts instead of anchor terms. Therefore the facts and their relationships to other facts can be used to determine a document footprint. Yet another embodiment includes a combination of using facts and anchor terms to determine relationships that could define a document footprint. Types of footprints include but are not limited to factual, document, event and matter. For example, a fact within a document can have a factual footprint and several factual footprints could be tied to a document footprint. Several document footprints could be clustered together because of their footprint similarity thus creating a cluster footprint. Alternatively several document footprints could be tied to an event footprint. Furthermore, several event footprints could be tied to a matter footprint. Ultimately, these matter footprints could be classified and integrated into a factual taxonomy. In an exemplary embodiment, a similarity threshold is implemented by determining a document commonality value and only allowing the documents at or above that value to be presented to the user. For example, if the commonality value is 80%, the query footprint and each document footprint must have at least a commonality value of 80% in order for the document and its associated document footprint to be listed in the results. This is only one embodiment of how similarity threshold is determined. Those of ordinary skill in the art know how to utilize various different similarity threshold values and methods.

Block 260 entails presenting search results. In the exemplary embodiment, this entails displaying a listing of one or more of the top ranked litigation documents in results region, such as region 1382 in FIG. 1. In some embodiments, the results may also include clusters of litigation documents that share similar document footprints within a certain threshold.

### Exemplary Search

In one exemplary embodiment, a user submits the following natural language query, “man gripping chest while in waiting room at Mayo Clinic.” This query is then transformed into a query footprint using normalization and parsing methods. For normalization, the words “while,” “in,” and “at” are removed from the query text. In addition, the word “gripping” is stemmed leaving the word grip. After normalization, the normalized query is as follows “man grip chest waiting room Mayo Clinic.” Then parsing the query identifies the following structure: man=noun; grip=verb; chest=noun; waiting room=anchor term/noun; Mayo Clinic=entity. The terms “waiting room” and “Mayo Clinic” are found to be an anchor term and an entity, respectively, because there are look up tables for medical terms/entities. The entity Mayo Clinic also can be resolved by knowing through tables that Mayo Clinic is a hospital so Mayo Clinic=entity and also Mayo Clinic=hospital=noun. By looking at these tables, it can be determined that “waiting room” and “Mayo Clinic” are phrases with a medical meaning or entity instead of two individual words. Finally after the parsing, a query footprint is creating; the query footprint being: man=noun; grip=verb; chest=noun; waiting room=anchor term/noun; Mayo Clinic=entity and/or noun. Now using this query footprint, the system can identify a document that has a document footprint similar to the query footprint. Let's presume that the similarity threshold is 75%. This means that the query footprint and the document footprint should have at least a 75% commonality value in order for the document and its corresponding document footprint to be transmitted to the user as a result. The document footprint in queue is: man=noun; hug=verb; chest=noun; waiting room=anchor term/noun; Mayo Clinic=entity. When deciding the commonality value for the query and document footprint, various factors can be taken into account such as weight given to each word or phrase, the proximity of the words to each other, and how many times the words or phrases appear in the document, etc. Assuming all the factors listed above were taken into account, the commonality value is 82%. Since the commonality value is greater than the similarity threshold of 75%, this document ultimately would be displayed to the user.

Another exemplary embodiment includes clustering document footprints and ultimately displayed the appropriate clusters to the user given his/her query. The same exemplary described in this section is applicable to identifying cluster footprints that should be displayed. However an additional step is needed to cluster the documents into similar bins. Such clustering techniques such as agglomerative hierarchical and K-means can be used (See “A Comparison of Document Clustering Techniques” by Michael Steinbach, et al. for a detailed description on various clustering techniques). Once the documents are clustered, a cluster footprint can be determined using one of the exemplary embodiments described therein.

### Exemplary Interfaces of Information Retrieval System

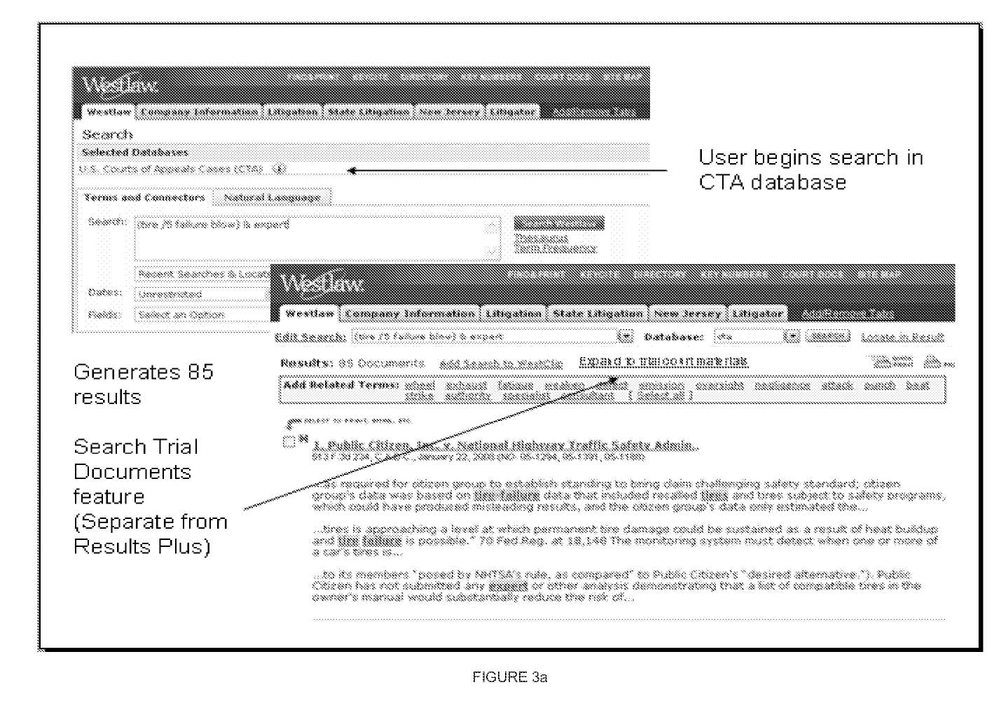

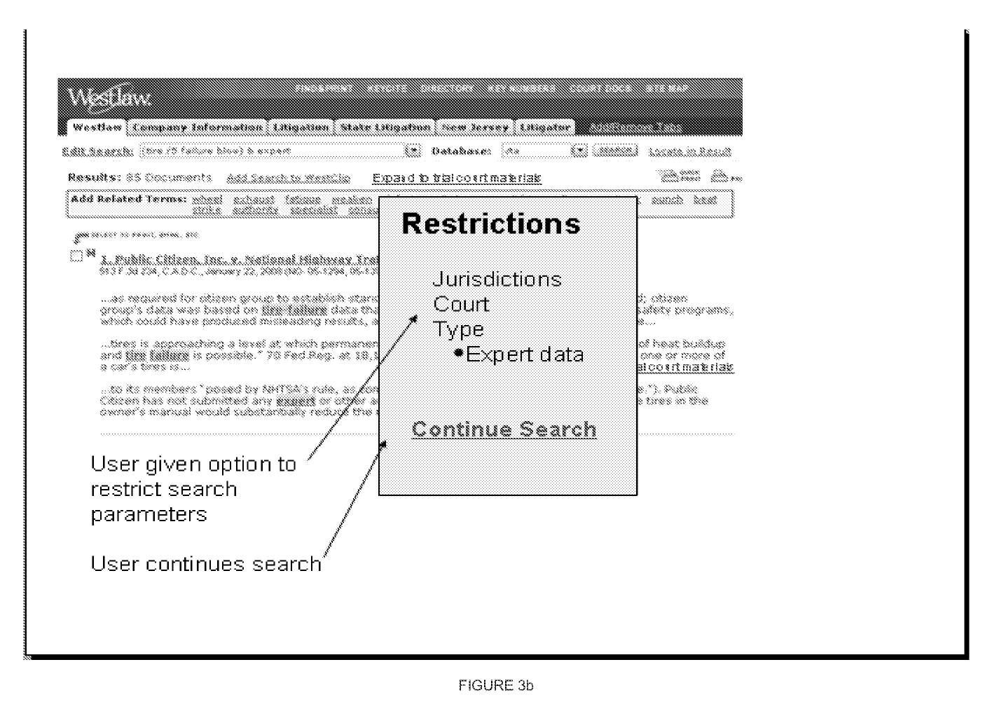

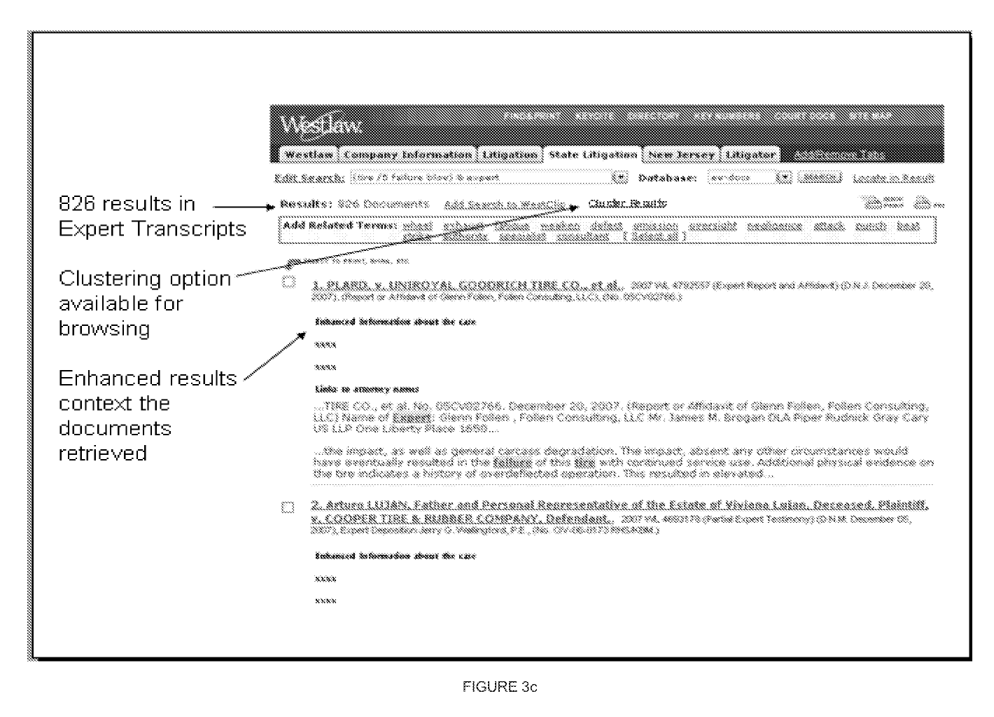

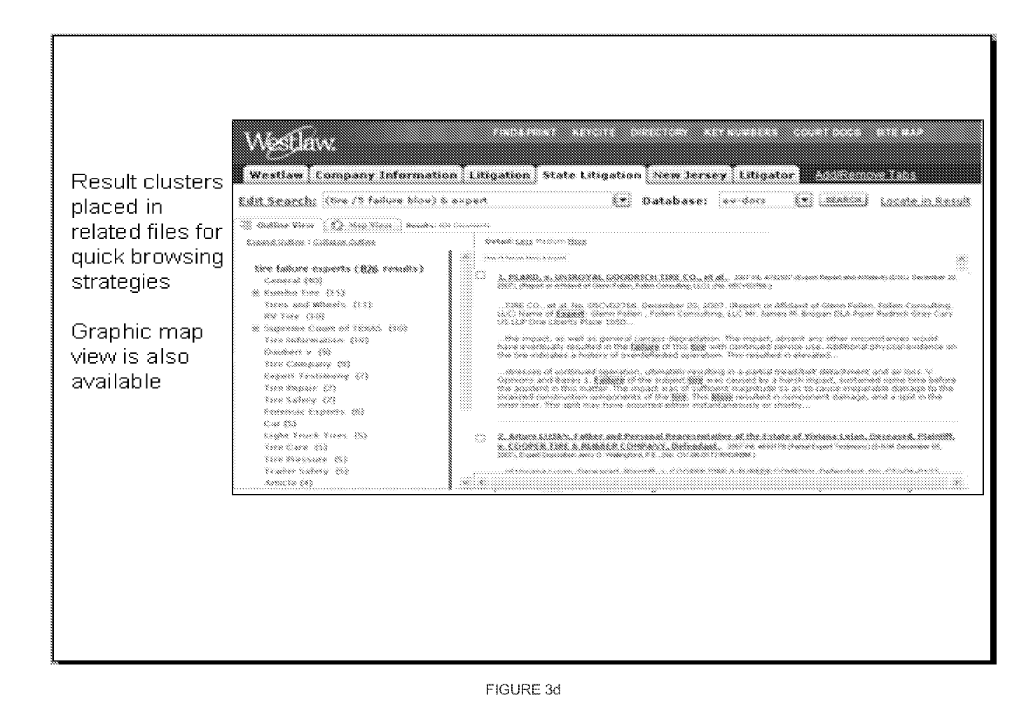

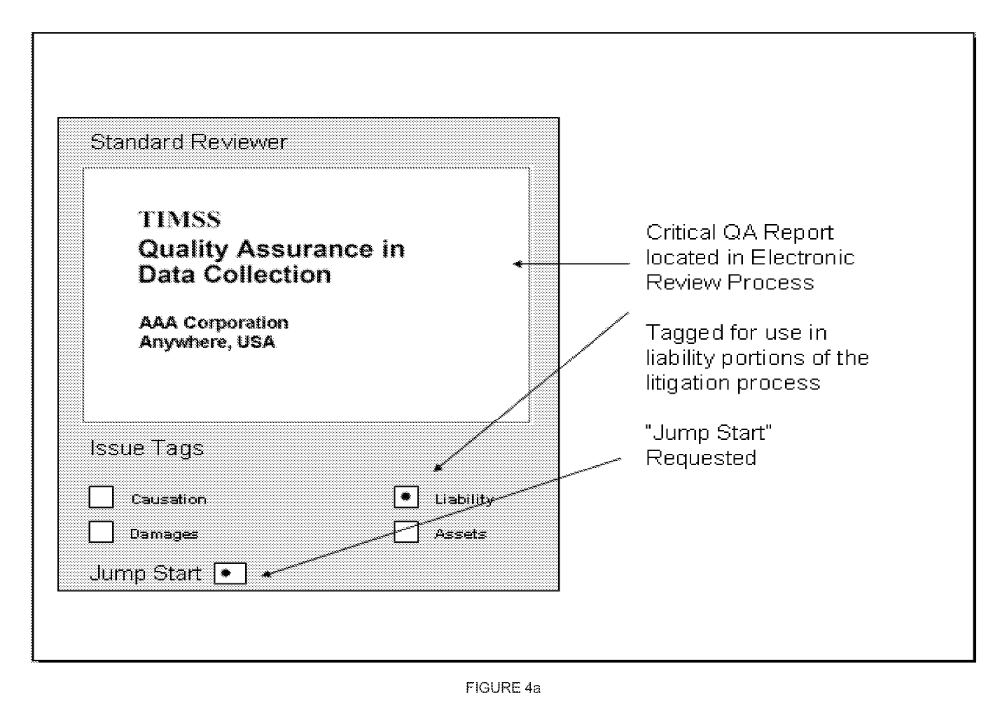

FIGS. 3a-d show detailed exemplary embodiments of presentation of results. FIG. 3a illustrates a user's search result. Also illustrated is the ability to click on the hyperlink entitled “Expand to Trial Court Material” which allows the user to expand his/her search to trial court materials. Once this hyperlink is selected, a pop-up window appears FIG. 3b, permitting the user to restrict the trial court materials by jurisdiction, court, type of document, etc. Assume the user has selected to restrict his/her search of trial court materials to only expert materials. FIG. 3c shows the result list of expert transcripts while utilizing the user's query. Also, the display allows the user to cluster these expert transcripts by selecting the “Cluster Results” hyperlink. Once selected, either an outline view or a map view of the cluster appears on the left pane of the user's interface FIG. 3d. The clustering lets the user navigate as needed to the area that he/she is interested in.

### Exemplary Integration with Case Management Tool

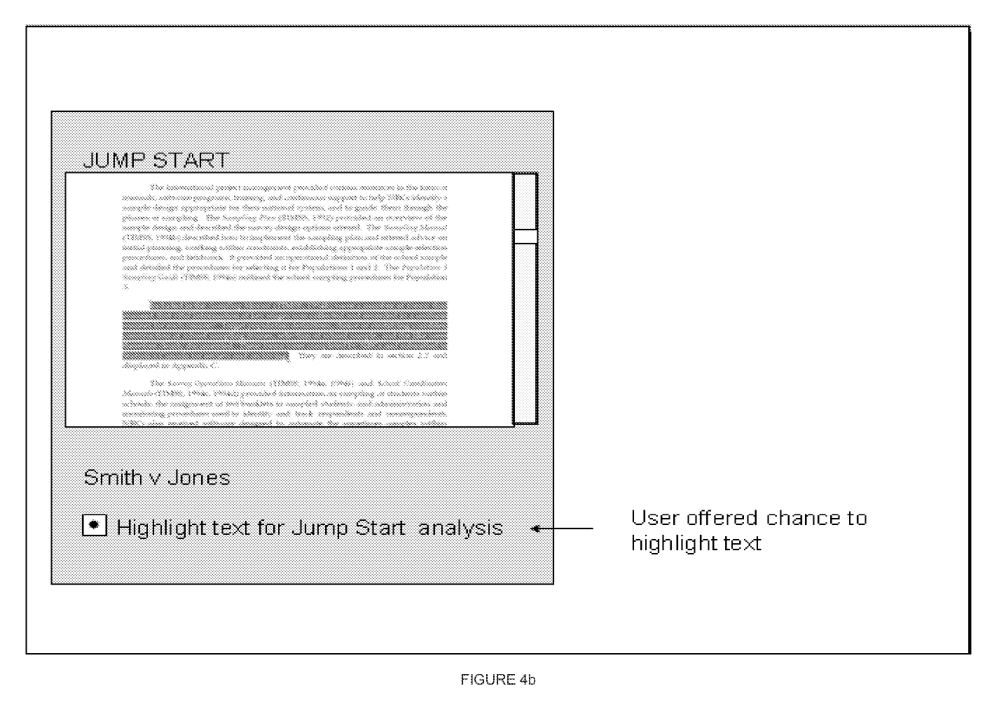

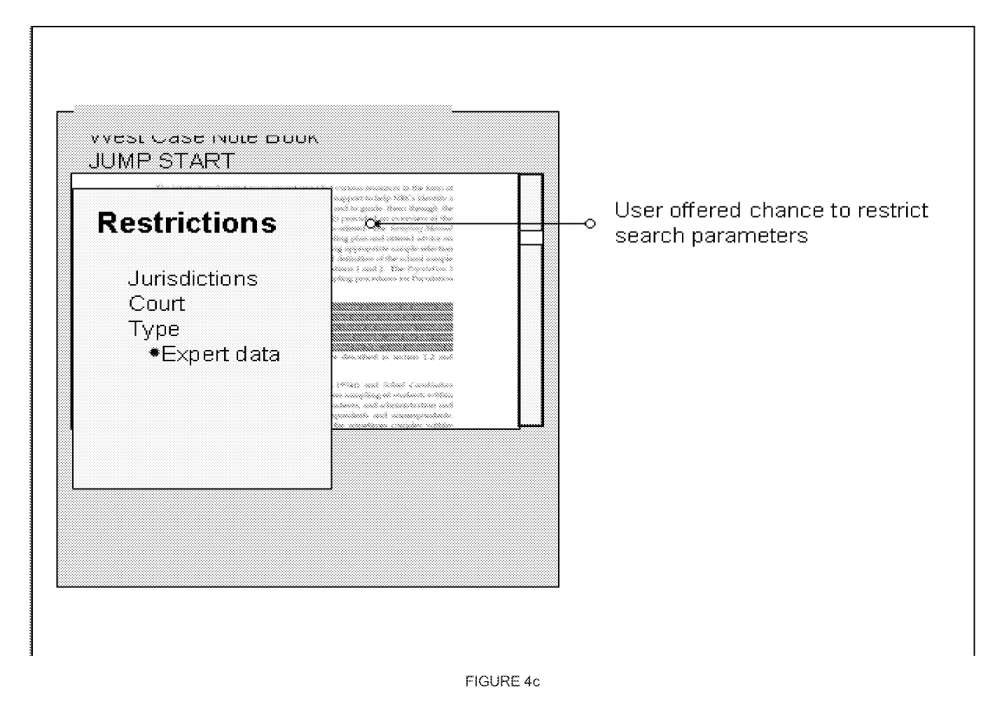

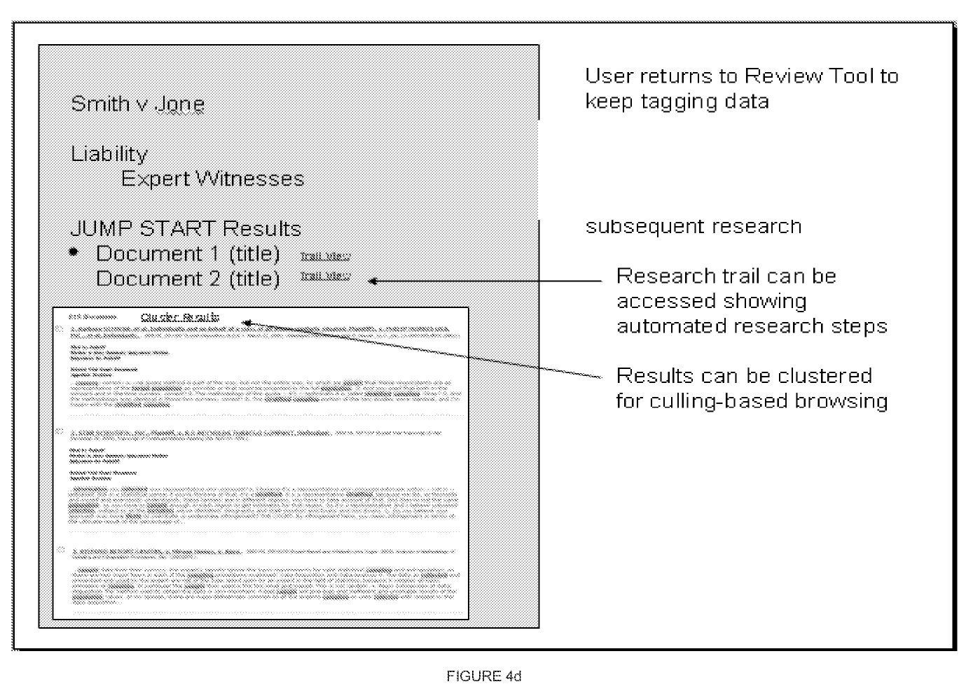

FIGS. 4a-d shows exemplary interfaces of a case management system being integrated with searching and retrieving litigation documents with similar fact descriptions. A document sent from a review tool to a case management system, or directly from a case management system, is tagged for a legal, procedural or factual issue FIG. 4a. A user is directed to highlight the portion of the text most significant to him/her FIG. 4b. Then a pop-up screen appears that allows but not require the user to enter additional information (i.e. jurisdictional restrictions, type of information searched (e.g., briefs, trial court docs, expert reports), procedural parameters (e.g., in limine) limiting the scope of research desired in interface familiar to review tool users FIG. 4c. The document as tagged is processed as though it was loaded to an information retrieval system with the fact-based structures in place. The factual description highlighted is summarized and reduced to metadata using automated processes. All other portions of the document are analyzed to determine the document type. Using the document type and the metadata, a set of result documents are then retrieved automatically using the system and methods as described above. The results of the automated search are delivered to the case management system within the file selected by the customer FIG. 4d. The results are a combination of annotated citation list and research trail, allowing linked access to an information retrieval system directly from a case management system.

### CONCLUSION

The embodiments described above are intended only to illustrate and teach one or more ways of practicing or implementing the present invention, not to restrict its breadth or scope. The actual scope of the invention is defined by the following claims and their equivalents.

What is claimed is:

1. A computer-implemented method comprising:
receiving a query wherein the query comprises at least one factual description;
transforming the query into a query footprint;
in response to the query, identifying a document having a pre-computed document footprint related to the query footprint by a similarity threshold; and
transmitting a signal representative of the document.

2. The method of claim 1 wherein the pre-computed document footprint having been determined by:
identifying at least one piece of factual description within at least one document;
tagging at least one the piece of factual description; and
extracting at least one the piece of factual description.

3. The method of claim 1 wherein the pre-computed document footprint having been determined by:
creating a relationship between a pair of anchor terms;
creating a relationship between an anchor term and a factual description; and
creating a relationship between an anchor term with a non-anchor term.

4. The method of claim 1 further comprising identifying a set of documents having a pre-computed cluster footprint related to the query footprint by a similarity threshold wherein the pre-computed cluster footprint includes at least two document footprints.

5. The method of claim 1 further comprising creating at least one factual taxonomy for at least one matter footprint; and aggregating at least one the factual taxonomy to at least one legal or procedural taxonomy.

6. The method of claim 5 further comprising integrating at least one workflow tool including but not limited to case management tools, drafting tools, presentation tools and document review tools.

7. The method of claim 1 wherein the document is a litigation document.

8. A system comprising:
a server for receiving a query, the server including a processor and a memory, the query comprising at least one factual description;
means for transforming the query into a query footprint;
means for identifying, in response to the query, a document having a pre-computed document footprint related to the query footprint by a similarity threshold; and
means for transmitting a signal representative of the document.

9. The system of claim 8 wherein the pre-computed document footprint having been determined by:
Means for identifying at least one piece of factual description within at least one document;
Means for tagging at least one the piece of factual description; and
Means for extracting at least one the piece of factual description.

10. The system of claim 8 wherein the pre-computed document footprint having been determined by:
Means for creating a relationship between a pair of anchor terms;
Means for creating a relationship between an anchor term and a factual description; and
Means for creating a relationship between an anchor term and a non-anchor term.

11. The system of claim 8 further comprising means for identifying a set of documents having a pre-computed cluster footprint related to the query footprint by a similarity threshold wherein the pre-computed cluster footprint includes at least two document footprints.

12. The system of claim 8 further comprising means for creating at least one factual taxonomy for at least one matter footprint; and means for aggregating at least one the factual taxonomy to at least one legal or procedural taxonomy.

13. The system of claim 12 further comprising means for integrating at least one workflow tool wherein the workflow tool including but not limited to case management tools, drafting tools, presentation tools and document review tools.

14. The system of claim 8 wherein the document is a litigation document.
